(19) United States
(12) Patent Application Publication
(10) Pub. No.: US 2002/0194691 A1
(43) Pub. Date: Dec. 26, 2002

(54) Paint roller with edge shield

(76) Inventor: Helmut R. Meyer, Otterville (CA)

Correspondence Address: YOUNG & BASILE, P.C., Suite 624, 3001 West Big Beaver Road, Troy, MI, 48084-3107, US

(21) Appl. No.: 09/891,698

(22) Filed: Jun. 26, 2001

(51) Int. Cl. B05C 17/02

(52) U.S. Cl. 15/230.11; 15/248.2

(57) ABSTRACT

A paint roller edge shield is pivotally carried on a base plate mounted on a paint roller handle and disposed in a first shielding position immediately adjacent a free end of a rotatable roller and moveable to a second position spaced from the free end of the roller to allow paint to be applied to the roller. The edge shield is pivotally coupled by a hinge to the base for pivotal movement between the first and second positions about a first axis. The edge shield includes first and second portions which are pivotally coupled for rotation of the first end portion relative to the second end portion about a second axis of rotation perpendicular to the first axis of rotation of the entire edge shield. At least one stop is formed between the mating portions of the first and second end portions of the edge shield to limit angular displacement of the first end portion relative to the second end portion of the edge shield.

### BACKGROUND

The present invention relates, in general, to shielding apparatus used in painting to protect adjacent surfaces from paint applied by brushes and, particularly, rollers.

When painting, a painter frequently encounters the edge of one surface being painted which abuts an adjacent surface. This can occur in the comer of a room between two adjacent walls, between a wall and an adjacent ceiling or trim molding, as well as around windows and doors where a frame or other surface being painted abuts a glass pane or screen.

Care must be taken so that paint being applied to one surface does not flow over or contact the adjacent surface. This can be accomplished by manually applying tape along the edge between the two surfaces to mask the adjacent surface while paint is being applied to the other surface. Care must also be taken when removing the tape to ensure that any wet paint still does not seep behind the tape onto the adjacent surface which is not to be painted.

Manually held shields are also known. Such shields may take a variety of forms but generally have a flat, straight edged surface which can be applied firmly on the surface which is not to be painted thereby allowing the painter to freely paint the adjacent surface or area. However, depending upon the angle of which such shields are held, paint can still seep around the edge of the shield onto the adjacent surface.

A variety of shields have also been mounted on paint brushes and rollers. With these types of shields, the brush or roller, or the shield must be able to be moved relative to the other to enable the brush or roller to be dipped into fresh paint for refilling.

It is believed that further improvements could be made to paint shields, particularly shields integrally mountable on paint rollers which provides the required shield function while at the same time being able to be easily applied to existing paint roller handles. It would also be desirable to provide a paint roller edge shield which is easily movable between operative and inoperative positions to provide both shielding and non-shielding functions wherein, when in the non-shielding position, the paint roller can be inserted into a tray for refilling of the roller with fresh paint.

### SUMMARY

The present invention is a paint roller apparatus with an edge shield for protection of surfaces adjacent to a surface having paint applied by the roller.

In one aspect of the invention, the paint roller apparatus includes a handle and a roller support attached to and projecting from the handle and rotatably supporting a roller cover. The roller cover terminates in a free end. An edge shield is carried on the handle. The edge shield is moveably coupled to the handle for movement from a first shielding position adjacent the free end of the roller cover and a second position spaced from the roller cover to allow paint to be applied to the roller cover.

The paint roller apparatus includes a base plate mountable on the handle, with the edge shield pivotally coupled to the base plate. A hinge pivotally couples the edge shield to the base.

The edge shield has first and second portions. The second portion is coupled to the handle. A pivot connection is carried on the first and second portions of the edge shield to allow the first portion of the edge shield to pivot relative to second portion of the edge shield.

The edge shield preferably includes a planar plate having first and second major side edges extending between opposed first and second ends. The first and second side edges taper from a large dimensional spacing at one at the second end of the edge shield to a smaller dimensional spacing at the first end of the edge shield.

The pivot connection between the first and second end portions of the edge shield defines an axis of rotation perpendicular to an axis of rotation of the edge shield relative to the base. The pivot connection includes an open ended slot formed in an end of the second end portion of the shield. A tongue extends from one end of the first end portion of the shield and is pivotally disposed in the slot. A pivot pin is carried in the second end portion of the shield and extends through the slot and the tongue on the first end portion.

A stop cooperates between the first and second portions of the edge shield limiting pivotal movement of the first end portion of the edge shield relative to the second end portion of the edge shield in one angular direction. Another stop cooperates between the first and second end portions of the edge shield, the second stop limiting angular movement of the first end portion of the edge shield with respect to the second end portion of the edge shield in a second angular direction opposite from the first angular direction. Either stop includes a projection extending from one of the first and second end portions of the shield, and a recess formed the other of the first and second end portions of the shield receiving the projection.

The invention also comprises an edge shield, as described above, mountable on a paint roller handle.

The unique paint roller apparatus with edge guard of the present invention provides a unique means for protecting surfaces adjacent to a surface being painted from contact with paint being applied by a roller. The edge shield is integrally carried on the roller by attachment to the handle thereby enabling the edge shield of the present invention to be mounted on many different paint roller configurations.

Uniquely, the edge shield is movably between a first shielding position wherein the edge shield is disposed immediately adjacent the free end of the paint roller, and a second non-shielding position wherein the edge shield is spaced from the insertion of the roller into a paint tray.

In addition, two portions of the edge shield are pivotal relative to each other thereby enabling the one side edge of the edge shield to be brought into contact with the joint between two adjacent surfaces such that the paint roller can contact the surface to be painted. This pivotal connection is bi-directional allowing the paint roller with edge shield of the present invention to be used with either the right or left hand as well as in any wall/surface configuration.

### BRIEF DESCRIPTION OF THE DRAWING

The various features, advantages and other uses of the present invention will become more apparent by referring to the following detailed description and drawing in which:

FIG. 1 is a perspective view of the paint roller edge shield of the present invention, with the shield shown in the shielding position;

FIG. 2 is an exploded, partial view of the edge shield showing the pivotal arrangement of the edge shield;

FIG. 3 is a partial side elevational view of the paint roller edge shield of the present invention in the non-shielding position; and

FIG. 4 is a partial, side elevational view of the edge shield in a paint applying position.

### DETAILED DESCRIPTION

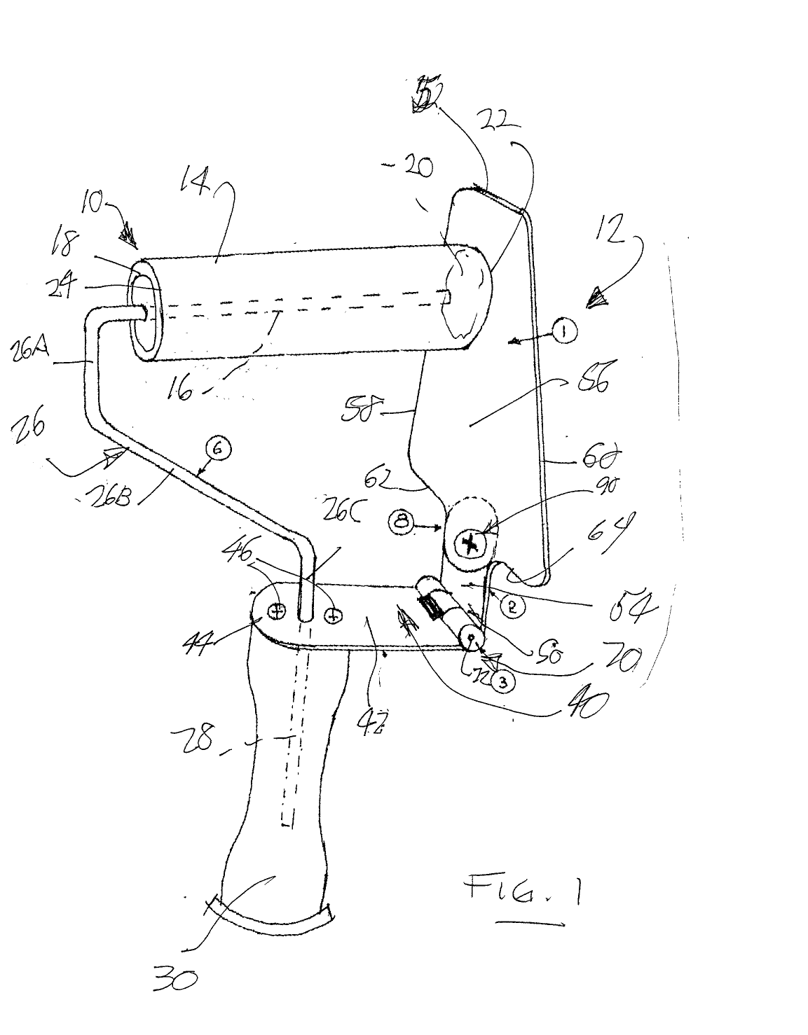

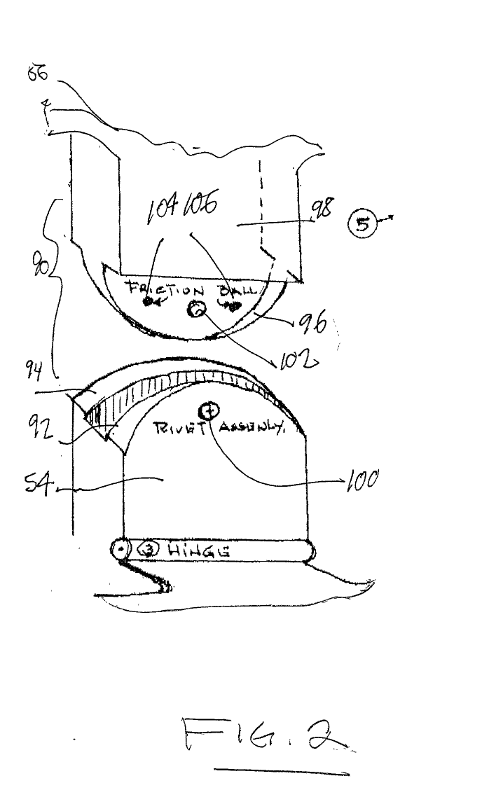

Referring now to of FIGS. 1-4, there is depicted a paint roller 10 with an edge shield 12 mounted thereon. In general, the edge shield 12 functions to shield the free end of the roller so as to prevent paint being applied by the roller onto one surface from reaching an adjacent surface located behind the edge shield 12. At the same time, the shield 12 is capable of movement in a direction away from the roller to a position allowing the roller to be dipped into a paint tray or other paint source for reapplying fresh paint on the roller.

The paint roller 10 has a conventional structure formed of a roller cover 14 formed of a course fabric capable of retaining paint. The roller cover 14 is rotatably mountable over a roller support shaft 16, typically by end plates 18 and 20 which fit into opposed ends of the generally cylindrical roller cover 14 and contain an aperture which receives the roller support rod 16 therethrough. The support rod 16 may be mounted in the end plates 18 and 20 by a press fit, or by means of an external fastener not shown.

The roller cover 14 as well as the internal support rod 16 may have a variety of lengths as is conventional in the painting industry. For example, roller covers 14 with a 4 inch trim length, or 8 inch, 10 inch, etc., may be provided along with a proportional increase in the length of the support rod 16.

The support rod 16 terminates in an outer end adjacent a free end 22 of the roller cover 14. The support rod 16 extends through the opposite end 24 of the roller cover 14 through a bent section denoted generally by reference number 26 to an end 28 fixedly mounted in a handle 30. The handle 30 typically has an ergonomic shape for easy gripping by a human hand.

The connector portion 26 of the support rod 16, by way of example only, includes a first bent portion 26A extending from the end of the support rod 16, an intermediate bent section 26B and a third bent section 26C which extends to the end portion 28 mounted in the handle 30.

In the configuration of the support rod 16 and the intermediate connector portion 26 shown in FIG. 1, by way of example only, the roller cover 14 is at least partially positioned in the same plane and extends over the handle 30. The free end 28 of the roller cover 14 extends to one side of the handle 30, beyond the side of the handle 30.

The edge or trim shield 12 of the present invention includes a handle mount 40. The handle mount 40 is in the form of a base plate 42 having a generally planar shape and formed of a suitable, durable material, such as metal, plastic, etc. One end 44 of the plate 42 has apertures formed therein which receive fasteners 46 for attaching the base plate 42 to the handle 30. Suitable threaded apertures or threaded bores in a solid end portion or ferrule mounted in the handle 30 may be used to securely receive the fasteners 46.

In this orientation, the base plate 42 also extends to one side of the handle 30, preferably to the same side as the free end 22 of the roller cover 14 and is generally parallel to the roller cover 14.

The base plate 42 supports the edge shield 12. The edge shield 12 also has a planar construction and is formed of a suitable material, such as metal or plastic, with plastic being preferred.

Although the edge shield 12 may take a variety of shapes, the shape shown in FIGS. 1, 3 and 4 and described hereafter will be understood to be preferred, although presented by way of example only. Thus, the edge shield 12 has a first end 50, an opposed second end 52, a stem 54 extending from the first end 50 and an enlarged shield portion 56 formed of tapered side edges 58 and 60 which extend between shoulders 62 and 64 extending from the stem 54. The tapered edges 58 and 60, which may be beveled, taper from a large interior dimension adjacent the stem 54 to a narrower dimension adjacent the second end 52.

The length of the shield 12 is chosen to enable a portion of the shield adjacent the second end 52 to extend beyond all exterior portions of the free end 22 of the roller cover 14.

The edge shield 12 is preferably moveably attached to the base plate 42. In a preferred aspect of the invention, the shield 12 is pivotally connected to the base plate 42 by means of a hinge 70, typically in the form of a leaf hinge having coaxially alignable mating portions on the first end 52 of the stem 54 of the shield 12 and the base plate 42 which receive a hinge pin 72 as shown in FIG. 1. Other constructions which provide a hinging action, with a large amount of angular travel of the edge shield 12 may also be provided.

FIG. 1 depicts the shielding position of the edge shield 12. In this position, one major surface of the shield 12 is in close proximity to or in contact with the free end 22 of the roller 14. The adjacent side edges 58 and 60 and the first end 52 of the shield 12 project outwardly from the periphery of the roller 14 to protect an adjacent surface from paint while another surface is contacted by roller cover 14.

At the same time, the edge shield 12 may be pivoted about the hinge 70 to a second, folded position shown in FIG. 4. This position represents the refilling position. Preferably, the shield 12 is capable of movement of at least 90°, with movement up to 180° being preferred. In this position, the edge shield 12 is spaced from the free end 22 of the roller 14 by a considerable distance thereby allowing the roller 14 to be easily dipped into a paint tray for refilling with fresh paint. After the fresh paint has been applied to the roller 12, the edge shield 12 is merely pivoted about the hinge 70 back to the first, shielding position shown in FIG. 1.

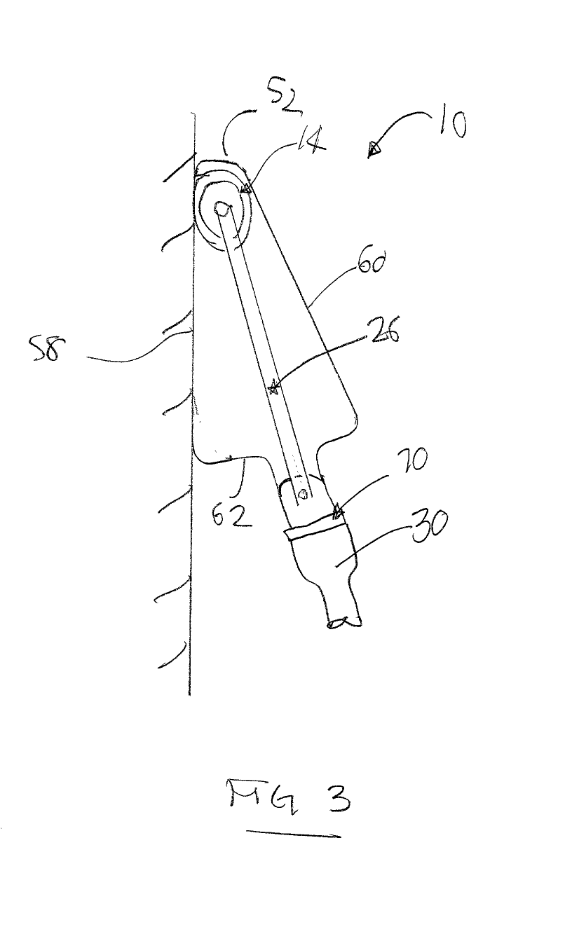

FIG. 3 depicts a use position of the edge shield 12 in conjunction with the application of paint by the roller 14 to first surface 18. According to this aspect of the invention, the edge shield 12 is provided with a pivotal movement about a second axis generally perpendicular to the axis of the hinge 70. The second axis is formed through the edge shield 12 generally at the intersection of the stem 54 and the enlarged shield portion 56.

The shield portion 56 is moveable relative to the stem 54 by means of a second hinge 90, as shown in FIG. 3. The hinge 90 includes a recess or mortice 92 formed in the stem 54. The recess 92 extends inward from first end 94 of the stem 54. A mating tongue or tenion 96 projects from an extension 98 of the shield portion 56 of the edge shield 12. The tongue 96 is sized to rotatably fit within the recess 92 in the stem 54. A pivot pin, such as a rivet 100, extends through the side walls surrounding the recess 92 in the stem 54 and a bore 102 formed in the end portion of the tongue 96. The tongue 96 and the recess 92 are sized for a relatively high friction or interference fit to enable the stem portion 54 and the shield portion 56 of the edge shield 12 to remain in any desired angular position, while still being easily movable to different angular positions depending upon the needs of the painter, as described hereafter.

A pair of stops in the form of projections or balls 104 and 106 are mounted in one of the tongue 96 and the inner walls of the stem 54 surrounding the recess 92. By example only, the projections 104 and 106 are mounted in and extend outward from one side surface of the end portion of the tongue 96. The projections 104 and 106 slidably engage the adjacent wall of the stem 54 in the recess 92 to control pivotal movement of the shield extension 98 relative to the stem 54 about the pivot pin 100. Stops in the form of depressions are formed in the adjoining wall of the stem 54 and the recess 92 to engage one of the projections 104 and 106 to prevent further angular movement of the shield portion 56 relative to the stem 54 in one direction.

In operation, it will be assumed that the shield portion 56 is in an upright, generally coaxial position with respect to the stem 54, as shown in FIG. 1. The fresh paint applied to the roller, the painter faces the surface 80 to be painted and places the edge 58 of the edge shield 12 on the edge between the surface 80 and the adjacent surface such that the main shield portion 56 of the edge shield 12 lies against the adjacent surface which is not to be painted, as shown in FIG. 3. Continued force in the direction of the surface 80 to be painted causes the shield portion 56 of the edge shield 12 to pivot about the hinge 90 relative to the stem 54 to a position, as shown by example in FIG. 3 in which the roller 14 contacts the surface 80. Movement of the roller 14 may commence along the edge between the surface 80 and the adjacent surface. At any time, the painter may remove the roller 14 from the surface 80 and manually pull or push the shield portion 56 back to the center, coaxial position relative to the stem 54, as shown in FIG. 1. However, it will be understood that the shield portion 56 may be in any angular position relative to the stem 54 when the shield 12, in its entirety, may be pivoted about the first hinge 70 to the second, non-shielding position. This enables fresh paint to be applied to the roller 14 or the use of the roller 14 over a large portion of the surface 80 away from any adjoining surfaces or edges which require the use of the edge shield 12.

Due to the symmetrical arrangement of the tapered edges 58 and 60 of the shield portion 56 about a center longitudinal axis of the edge shield 12, the edge shield 12 and the roller 14 may be used in either of the painter's left or right hands as well as on any orientation of surfaces to be painted and non-painted.

What is claimed is:

1. In a paint roller apparatus having a handle, and a roller attached to and projecting from the handle, the roller terminating in a free end, the improvement comprising:
an edge shield carried on the handle, the edge shield moveably coupled to the handle for movement from a first shielding position adjacent the free end of the roller cover and a second position spaced from the roller to allow paint to be applied to the roller.

2. The improvement of claim 1 further comprising:
a base plate mountable on the handle; and
the edge shield movably coupled to the base plate.

3. The improvement of claim 2 further comprising:
a hinge pivotally coupling the edge shield to the base plate.

4. The improvement of claim 2 further comprising:
the edge shield having first and second portions, the second portion coupled to the handle; and
a pivot connection carried on the first and second portions of the edge shield to allow the first portion of the edge shield to pivot relative to second portion of the edge shield.

5. The improvement of claim 4 wherein:
the pivot connection between the first and second end portions of the edge shield defines an axis of rotation perpendicular to an axis of rotation of the edge shield relative to the handle.

6. The improvement of claim 4 further comprising:
a stop cooperating between the first and second portions of the edge shield limiting pivotal movement of the first end portion of the edge shield relative to the second end portion of the edge shield in one angular direction.

7. The apparatus of claim 6 further comprising:
another stop cooperating between the first and second end portions of the edge shield, the second stop limiting angular movement of the first end portion of the edge shield with respect to the second end portion of the edge shield in a second angular direction opposite from the first angular direction.

8. The improvement of claim 6 wherein the stop comprises:
a projection extending from one of the first and second end portions of the shield; and
a recess formed the other of the first and second end portions of the shield for receiving the projection.

9. The improvement of claim 4 wherein the pivot connection comprises:
an open ended slot formed in the second end portion of the shield;
a tongue extending from the first end portion of the edge shield and pivotally disposed in the slot; and
a pivot pin extending through the slot and the tongue.

10. The paint roller apparatus of claim 1 wherein the edge shield further comprises:
a planar plate having first and second major side edges extending between opposed first and second ends, the first and second side edges tapering from a large dimensional spacing at the second end of the edge shield to a smaller dimensional spacing at the first end of the edge shield.

11. A paint roller apparatus comprising:
a handle;
a roller support attached to and projecting from the handle and rotatably supporting a roller cover, the roller cover terminating in a free end; and
an edge shield carried on the handle, the edge shield moveably coupled to the handle for movement from a first shielding position adjacent the free end of the roller cover and a second position spaced from the roller cover to allow paint to be applied to the roller cover.

12. The paint roller apparatus of claim 11 further comprising:
a base plate mountable on the handle;
the edge shield movably coupled to the base plate.

13. The paint roller apparatus of claim 12 further comprising:
a hinge pivotally coupling the edge shield to the base plate.

14. The paint roller apparatus of claim 11 further comprising:
the edge shield having first and second portions, the second portion coupled to the handle; and
a pivot connection carried on the first and second portions of the edge shield to allow the first portion of the edge shield to pivot relative to second portion of the edge shield.

15. The paint roller apparatus of claim 14 wherein:
the pivot connection between the first and second end portions of the edge shield defines an axis of rotation perpendicular to an axis of rotation of the edge shield relative to the handle.

16. The paint roller apparatus of claim 14 further comprising:
a stop cooperating between the first and second portions of the edge shield limiting pivotal movement of the first end portion of the edge shield relative to the second end portion of the edge shield in one angular direction.

17. The paint roller apparatus of claim 16 further comprising:
another stop cooperating between the first and second end portions of the edge shield, the second stop limiting angular movement of the first end portion of the edge shield with respect to the second end portion of the edge shield in a second angular direction opposite from the first angular direction.

18. The paint roller apparatus of claim 16 wherein the stop comprises:
a projection extending from one of the first and second end portions of the shield; and
a recess formed the other of the first and second end portions of the shield for receiving the projection.

19. The paint roller apparatus of claim 14 wherein the pivot connection comprises:
an open ended slot formed in the second end portion of the shield;
a tongue extending from the first end portion of the edge shield and pivotally disposed in the slot; and
a pivot pin extending through the slot and the tongue.

20. The paint roller apparatus of claim 11 wherein the edge shield further comprises:
a planar plate having first and second major side edges extending between opposed first and second ends, the first and second side edges tapering from a large dimensional spacing at the second end of the edge shield to a smaller dimensional spacing at the first end of the edge shield.

21. A paint roller apparatus comprising:
a handle;
a roller support attached to and projecting from the handle and rotatably supporting a roller cover, the roller cover terminating in a free end; and
an edge shield carried on the handle, the edge shield moveably coupled to the handle for movement from a first shielding position adjacent the free end of the roller cover and a second position spaced from the roller cover to allow paint to be applied to the roller cover, the edge shield including:
first and second portions;
a pivot connection carried on the first and second portions of the edge shield to allow the first portion of the edge shield to pivot relative to second portion of the edge shield;
a base plate mountable on the handle;
the edge shield movably coupled to the base plate; and
a hinge pivotally coupling the edge shield to the base plate.
